(19) United States
(12) Patent Application Publication
(10) Pub. No.: US 2010/0151296 A1
(43) Pub. Date: Jun. 17, 2010

(54) ELECTRODE CATALYST FOR FUEL CELL AND FUEL CELL INCLUDING ELECTRODE HAVING ELECTRODE CATALYST

(75) Inventors: Kang Hee Lee, Suwon-si (KR); Kyung-jung Kwon, Suwon-si (KR); Chan-ho Park, Seoul (KR); Seon-ah Jin, Pocheon-si (KR)

Correspondence Address: STEIN MCEWEN, LLP, 1400 EYE STREET, NW, SUITE 300, WASHINGTON, DC, 20005, US

(73) Assignee: Samsung Electronic Co., Ltd., Suwon-si (KR)

(21) Appl. No.: 12/634,043

(22) Filed: Dec. 9, 2009

(30) Foreign Application Priority Data
Dec. 16, 2008 (KR) 10-2008-0128185

(51) Int. Cl. H01M 8/10; H01M 4/00; H01M 4/88

(52) U.S. Cl. 429/30; 429/44; 502/101

(57) ABSTRACT

An electrode catalyst for a fuel cell and a fuel cell including an electrode having the electrode catalyst, include a non-platinum (Pt) catalyst, and a cerium (Ce) metal catalyst, both of which are supported on a carbon-based catalyst support having an improved catalytic activity at a decreased cost. The non-Pt catalyst may be at least one selected from the group consisting of Mn, Pd, Ir, Au, Cu, Co, Ni, Fe, Ru, WC, W, Mo, Se, any alloys thereof, and any mixtures thereof, and the Ce metal catalyst may be a Ce oxide.

### CROSS-REFERENCE TO RELATED APPLICATION

This application claims the benefit of Korean Patent Application No. 10-2008-0128185, filed Dec. 16, 2008, in the Korean Intellectual Property Office, the disclosure of which is incorporated herein by reference.

### BACKGROUND OF THE INVENTION

1. Field

Embodiments relate to an electrode catalyst for fuel cells, a method of manufacturing the same, and a fuel cell including an electrode having the electrode catalyst.

2. Description of the Related Art

Fuel cells generate electrical energy by a reaction, which generates water from hydrogen and oxygen. Hydrogen is obtained by reacting raw materials, such as methanol and water, in the presence of a reformer catalyst. Such fuel cells may be classified into polymer electrolyte membrane fuel cells (PEMFCs), direct methanol fuel cells (DMFCs), phosphoric acid fuel cells (PAFCs), molten carbonate fuel cells (MCFCs), and solid oxide fuel cells (SOFCs), depending on the types of electrolytes and fuels used. The operating temperatures and properties of the components of fuel cells vary according to the electrolytes used.

In general, PEMFCs and DMFCs are formed of an anode, a cathode, and a membrane-electrode assembly (MEA) including a polymer electrolyte membrane disposed between the anode and the cathode. The anode includes a catalytic layer to facilitate oxidation of a fuel, and the cathode includes a catalytic layer to facilitate the reduction of an oxidant.

In general, a catalyst having platinum (Pt) as an active element is used as a component of the catalytic layers of the anode and the cathode. However, although Pt is a noble metal, the amount of Pt used in the electrode catalysts for mass production of fuel cells is large, and thus, manufacturing costs are high. Therefore, research is being actively conducted to develop non-Pt electrode catalysts and fuel cells having high cell performance employing the non-Pt electrode catalysts.

### SUMMARY

Embodiments include an electrode catalyst for a fuel cell, wherein the electrode catalyst has improved catalytic activity due to the inclusion of a cerium oxide, and a fuel cell including an electrode having the electrode catalyst.

Additional aspects will be set forth in part in the description which follows and, in part, will be apparent from the description, or may be learned by practice of the presented embodiments.

Embodiments may include an electrode catalyst for a fuel cell, the electrode catalyst including: a carbon-based catalyst support; and a non-platinum (Pt) catalyst; and a cerium (Ce) metal catalyst, wherein the non-Pt catalyst and the Ce metal catalyst are both supported on the carbon-based catalyst support.

According to aspects, the amount of the non-Pt catalyst may be 10 to 70 parts by weight, the amount of the Ce metal catalyst may be 0.1 to 30 parts by weight, and the amount of the carbon-based catalyst support may be 29.9 to 60 parts by weight, based on 100 parts by weight of the electrode catalyst.

According to aspects, the non-Pt catalyst may include at least one selected from the group consisting of Mn, Pd, Ir, Au, Cu, Co, Ni, Fe, Ru, tungsten carbide (WC), W, Mo, Se, any alloys thereof, and any mixtures thereof.

According to aspects, the non-Pt catalyst may include one selected from the group consisting of Mn, Pd, Ir, Au, Cu, Ni, Fe, Ru, WC, W, Mo, Se, and Co.

According to aspects, the non-Pt catalyst and the Ce metal catalyst may be disposed adjacent to each other on the carbon-based catalyst support.

According to aspects, the Ce metal catalyst may include a Ce oxide.

According to aspects, the carbon-based catalyst support may include one selected from the group consisting of Ketchen black, carbon black, graphite carbon, carbon nanotube, and carbon fiber.

Embodiments may include a method of manufacturing an electrode catalyst for fuel cells, the method including: mixing a non-platinum (Pt) catalyst precursor and a cerium (Ce) precursor in a solution to form a mixture solution; impregnating a carbon-based catalyst support with the mixture solution; and heat treating the resultant of the impregnation under a hydrogen atmosphere at a temperature of about 200 to about 350° C.

Embodiments may include a fuel cell including: an electrode including an electrode catalyst for a fuel cell; and an electrolyte membrane. According to aspects, the electrode may be a cathode.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 is a diagram schematically illustrating an electrode catalyst for a fuel cell, according to an embodiment;

FIG. 2 is a flowchart schematically illustrating a method of manufacturing the electrode catalyst for a fuel cell of FIG. 1, according to an embodiment;

FIG. 3 is a spectrum illustrating a result of analysis of an, electrode catalyst of Example 1 using X-ray photoemission spectroscopy (XPS), according to an embodiment;

FIG. 4 is a graph illustrating the activity of oxygen reduction reaction (ORR) of electrode catalysts of Example 1 and Comparative Example 1;

FIG. 5 is a graph showing the change in potential according to the current density with respect to fuel cells manufactured using the electrode catalysts of Example 1 and Comparative Example 1;

FIG. 6 is an exploded perspective view of a fuel cell according to an embodiment; and

FIG. 7 is a cross-sectional view of a membrane-electrode assembly (MEA) of the fuel cell of FIG. 6.

### DETAILED DESCRIPTION

Reference will now be made in detail to the embodiments, examples of which are illustrated in the accompanying drawings, wherein like reference numerals refer to the like elements throughout. The embodiments are described below in order to explain aspects thereof with reference to the figures.

An electrode catalyst for a fuel cell according to an embodiment includes: a carbon-based catalyst support; a non-platinum (Pt) catalyst supported on the carbon-based catalyst support; and a cerium (Ce) metal catalyst.

General fuel cells include a solid polymer membrane disposed between an anode including a Pt catalytic layer and a cathode including a Pt catalytic layer. In the anode, the following reaction occurs due to the Pt catalytic layer.

H₂→2H⁺+2e⁻

H⁺ produced from the reaction diffuses into an electrolyte. In addition, in the cathode, the following reaction occurs due to the Pt catalytic layer.

2H⁺+2e⁻+½O₂→H₂O

The electrode catalyst according to the present embodiment uses the non-Pt catalyst and the Ce metal catalyst instead of a general Pt catalyst, thereby providing a polymer electrolyte membrane fuel cell (PEMFC), a phosphoric acid fuel cell (PAFC), or a direct methanol fuel cell (DMFC) with excellent electrode catalytic activity.

Moreover, the electrode catalyst according to the present embodiment also uses a metal catalyst derived from cerium oxide having excellent oxygen activity or transferability, thereby providing an electrode catalyst for a fuel cell having excellent activity even at temperatures less than 200° C.

The electrode catalyst according to the present embodiment may include the non-Pt catalyst and the Ce metal catalyst. The non-Pt catalyst may be formed of at least one selected from the group consisting of Mn, Pd, Ir, Au, Cu, Co, Ni, Fe, Ru, tungsten carbide (WC), W, Mo, Se, any alloys thereof, and any mixtures thereof.

According to an embodiment, the non-Pt catalyst may be formed of one selected from the group consisting of Mn, Pd, Ir, Au, Cu, Ni, Fe, Ru, WC, W, Mo, Se, and Co.

According to an embodiment, the non-Pt catalyst may be formed of at least one selected from the group consisting of Pd, PdCo, PdNi, PdFe, PdAu, Ir, IrCo, IrFe, IrAu, IrPd, PdIrCo, PdIrMn, any alloys thereof, and any mixtures thereof.

The electrode catalyst for a fuel cell according to the present embodiment may include 10 to 70 parts by weight of the non-Pt catalyst, 0.1 to 30 parts by weight of the Ce metal catalyst, and 29.9 to 60 parts by weight, of the carbon-based catalyst support, based on 100 parts by total weight of the electrode catalyst. The balance of weights of the non-Pt catalyst, the Ce metal catalyst, and the carbon-based catalyst support may be selected in view of the electrochemical surface area and oxygen reduction reaction (ORR) of the catalyst. Here, the total weight of the electrode catalyst denotes a total weight of the non-Pt catalyst, the catalyst support, and Ce metal catalyst.

The electrode catalyst according to the present embodiment may be represented by PdₐCo_{b}(CeO_{X})_{c}. Here, a, b, and c respectively represent a combined number of each element, wherein a is in the range of about 1.0 to about 5.0, b is in the range of about 0.5 to about 2.0, c is in the range of about 0.1 to about 2.0, CeO_{X} is a mixture of CeO₂ and Ce₂O₃, and x is in the range of about 1.5 to about 2.

FIG. 1 is a diagram schematically illustrating the electrode catalyst for a fuel cell, according to the present embodiment. Referring to FIG. 1, the electrode catalyst for a fuel cell according to the present embodiment includes a non-Pt based catalyst as a first metal catalyst 1 and a Ce catalyst as a second metal catalyst 2 supported by a carbon-based catalyst support 3. The first metal catalyst 1 and the second metal catalyst 2 may be disposed adjacent to each other.

The second metal catalyst 2 has excellent transferability of oxygen to be transferred to the adjacent first metal catalyst 1, and facilitates the ORR of the electrode catalyst.

Also, in terms of the activity of the fuel cell, the non-Pt catalyst, i.e., the first metal catalyst 1, may formed of at least one selected from the group consisting of Mn, Pd, Ir, Au, Cu, Co, Ni, Fe, Ru, tungsten carbide (WC), W, Mo, Se, any alloys thereof, and any mixtures thereof.

In addition, the non-Pt catalyst, i.e., the first metal catalyst 1, may be formed of one selected from the group consisting of Mn, Pd, Ir, Au, Cu, Ni, Fe, Ru, WC, W, Mo, Se, and Co. Here, the amount of the first metal catalyst 1, for example, Co, may be about 5 to about 50 parts by weight based on 100 parts by weight of the non-Pt catalyst, i.e., the first metal catalyst 1.

Moreover, the non-Pt catalyst, i.e., the first metal catalyst 1, may be formed of at least one selected from the group consisting of Pd, PdCo, PdNi, PdFe, PdAu, Ir, IrCo, IrFe, IrAu, IrPd, PdIrCo, PdIrMn, any alloys thereof, and any mixtures thereof.

The carbon-based catalyst support 3 may be formed of one selected from the group consisting of Ketchen black, carbon black, graphite carbon, carbon nanotube, and carbon fiber, each having high electric conductivity and large surface area.

The electrode catalyst for a fuel cell according to the present embodiment may be manufactured using a colloidal method.

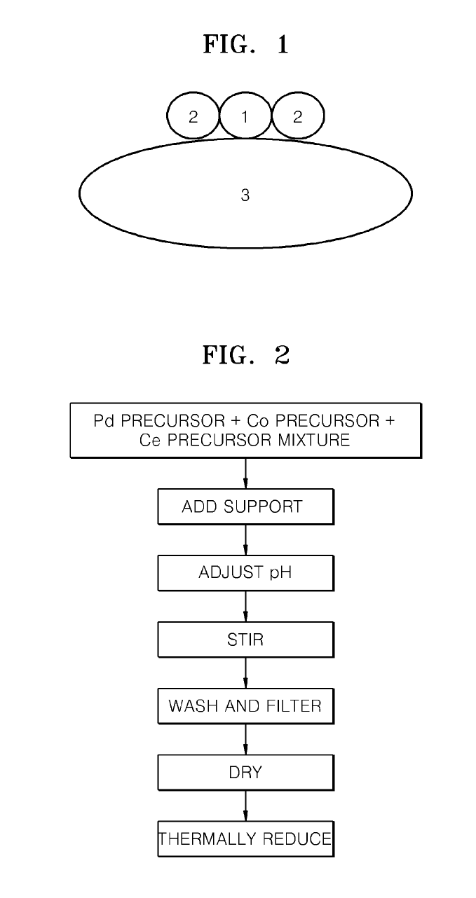

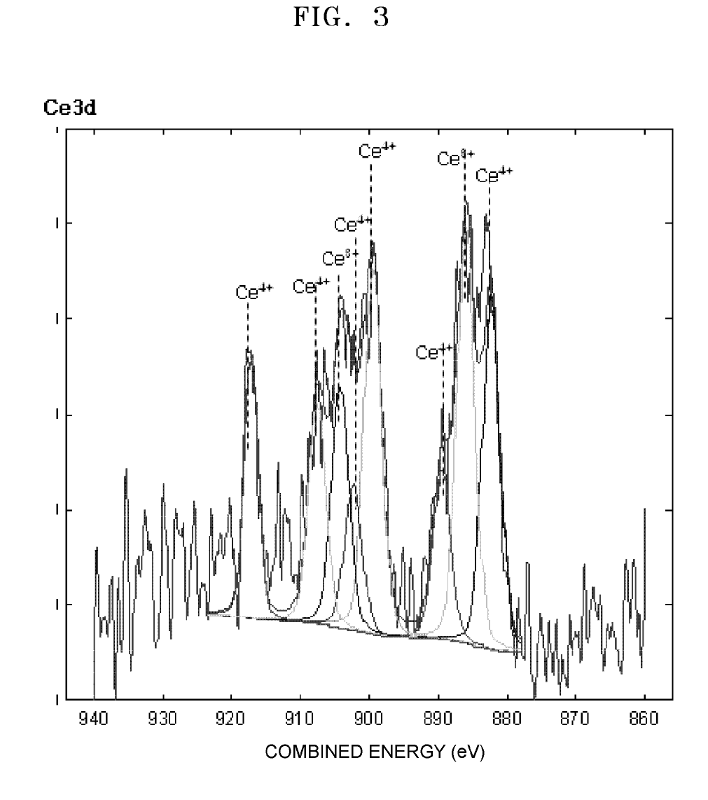

FIG. 2 is a flow chart schematically illustrating a method of manufacturing the electrode catalyst for a fuel cell, according to an embodiment. First, a solution of a palladium (Pd) precursor, a Ce precursor, and a cobalt (Co) precursor dissolved in water is mixed. A carbon-based support is then added to the solution of Pd, Ce, and Co precursors. Then, the pH of the mixture is adjusted, and the pH adjusted mixture is stirred to impregnate the carbon-based support with a mixture of the Pd precursor, the Ce precursor, and the Co precursor.

Examples of the Pd precursor may include palladium(II) chloride, palladium(II) acetylacetonate, palladium(II) cyanide, palladium(II) acetate, palladium(II) sulfides, and palladium(II) nitrates.

Examples of the Ce precursor may include ammonium cerium(IV) nitrate, cerium(III) acetate, cerium(III) bromide, cerium(III) carbonate, cerium(III) chloride, cerium(IV) hydroxide, cerium(III) nitrate, cerium(III) sulfate, cerium(IV) sulfate, and Ce.

Examples of the Co precursor may include cobalt(II) chloride (CoCl₂), cobalt(II) sulfate (CoSO₄), and cobalt(II) nitrate (Co(NO₃)₂). Here, under a basic condition of pH 7 or above, the mixture including the Pd precursor, the Ce precursor, and the Co precursor is well impregnated into the carbon-based support.

The resultant is washed several times, dried, and thermally reduced to obtain the electrode catalyst for a fuel cell according to an embodiment. The thermal reduction may be performed under a hydrogen atmosphere at a temperature of about 200 to about 350° C. for about 0.5 to about 4 hours. As a result of the thermal reduction, the electrode catalyst has excellent activity, and shows a significantly increased oxidation/reduction current in the voltage range of about 0.6 to about 0.8 V, which is the approximate voltage range of an electrode.

In addition, a fuel cell including the electrode catalyst described above is provided, according to an embodiment. The fuel cell of the present embodiment includes a cathode, an anode, and an electrolyte membrane disposed between the cathode and the anode, wherein at least one of the cathode and the anode contains the electrode catalyst for a fuel cell according to the embodiment described above. For example, the supported catalyst of the present embodiment is applied to the cathode. The fuel cell of the present embodiment may be implemented as, for example, a PAFC, a PEMFC, or a DMFC. The fuel cell of the present embodiment may be a PEMFC.

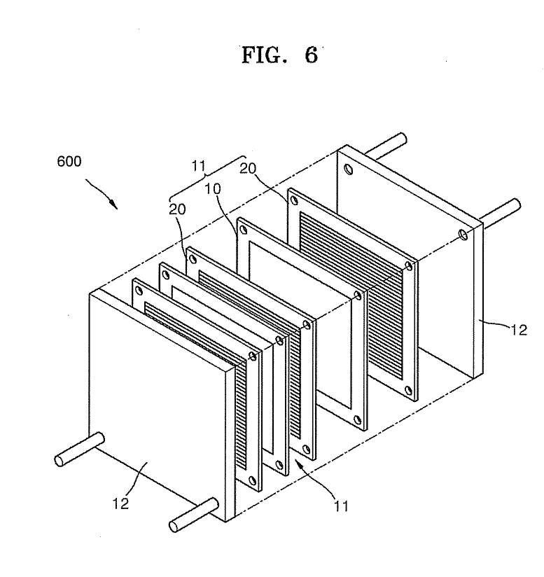

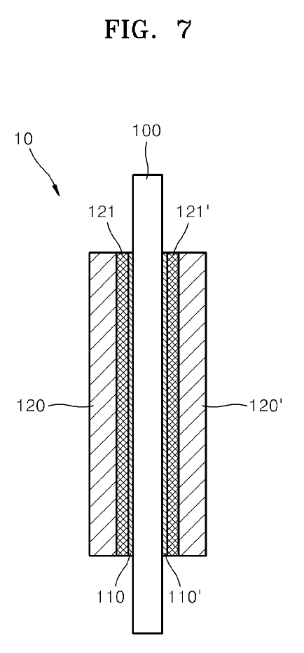

FIG. 6 is an exploded perspective view of a fuel cell 600, according to an embodiment, and FIG. 7 is a cross-sectional view of a membrane-electrode assembly (MEA) 10 of the fuel cell 600 of FIG. 6. Referring to FIG. 6, the fuel cell 600 according to the present embodiment includes two unit cells 11 disposed between a pair of holders 12. Each unit cell 11 includes an MEA 10 and bipolar plates 20 disposed on both sides of the MEA 10. The bipolar plates 20 are formed of a conductive metal, carbon or the like, and are attached to the MEA 10 so that the bipolar plates 20 collect current and provide oxygen and fuel to the catalytic layers (110 and 110′ in FIG. 7) of the MEA 10. The number of unit cells 11 present in the fuel cell 600 of FIG. 6 is two. However, the number of unit cells 11 is not limited to two and may be increased to several tens or hundreds, depending on the properties of the fuel cell 600.

Referring to FIG. 7, the MEA 10 includes an electrolyte membrane 100, catalytic layers 110 and 110′ according to the present embodiment respectively disposed on both sides of the electrolyte membrane 100, first gas diffusion layers 121 and 121′ respectively stacked on the catalytic layers 110 and 110′, and second gas diffusion layers 120 and 120′ respectively stacked on the first gas diffusion layers 121 and 121′.

The catalytic layers 110 and 110′ are a fuel electrode and an oxygen electrode, respectively, each including a catalyst and a binder therein, and may further include a material that may increase the electrochemical surface area thereof.

The first gas diffusion layers 121 and 121′ and the second gas diffusion layers 120 and 120′ may each be formed of, for example, a carbon sheet or a carbon paper, and diffuse oxygen and fuel supplied through the bipolar plates 20 to the entire surfaces of the catalytic layers 110 and 110′.

The fuel cell 600 including the MEA 10 operates at a temperature of about 100 to about 300° C. Fuel, such as hydrogen, is supplied through one of the bipolar plates 20 into the catalytic layer 110, and an oxidant, such as oxygen, is supplied through the other bipolar plate 20 into the catalytic layer 110′. Then, hydrogen is oxidized in the catalytic layer 110, thereby producing protons. These protons are transferred through the electrolyte membrane 100 by conduction to reach the catalytic layer 110′, and the protons and oxygen electrochemically react to produce water in the catalytic layer 110′ and to produce electrical energy. Moreover, the hydrogen supplied as a fuel may be hydrogen produced by reforming hydrocarbons or alcohols, and the oxygen supplied as an oxidant may be supplied in the form of air.

One or more embodiments will be described in greater detail with reference to the following examples. The following examples are not intended to limit the scope of the embodiments.

In the examples below, CeO_{X} represents a mixture of CeO₂ and Ce₂O₃ and x is in the range of about 1.5 to about 2.

### Example 1

### Manufacture of Pd₃Co₁(CeO_{X})₁ Ternary Electrode Catalyst

0.5 g of CoCl₂.6H₂O as a Co precursor and 0.5 g of (NH₄)₂Ce(NO₃)₆ as a Ce precursor were added to 200 g of 1M solution of 1 g of Pd nitrate hydrate (Pd(NO₃)₂.XH₂O) as a Pd precursor dissolved in water and then 0.5 g of Ketchen black as carbon-based catalyst support was added to the mixture solution.

In order to adjust the pH of the mixture to be basic, 1M of sodium hydroxide solution was dropwise added to the mixture solution, and stirring was performed for 12 hours to form a precipitate. The resultant precipitate was washed several times with water, and then was dried under a nitrogen atmosphere at a temperature of about 120° C.

Then, the resultant solid product was heat-treated at a temperature of about 300° C. in hydrogen gas to complete the manufacture of an electrode catalyst for a fuel cell. The mixture ratio of the metals in the resultant electrode catalyst, represented by Pd₃Co₁(CeO_{X})₁, could be analyzed using an inductively coupled plasma (ICP) analyzing method.

FIG. 3 is a spectrum illustrating a result of analysis of the electrode catalyst of Example 1 using X-ray photoemission spectroscopy (XPS).

The oxidation number of Ce existing on the surface of the electrode catalyst was analyzed using XPS. As a result, it was found that Ce³⁺ and Ce⁴⁺ ions were present and thus, Ce was shown to exist as an oxide in the form of Ce₂O₃ and CeO₂ crystals.

### Comparative Example 1

### Manufacture of Pd₃Co₁ Electrode Catalyst

0.5 g of CoCl₂.6H₂O as a Co precursor was added to 200 g of 1M solution of 1 g of Pd nitrate hydrate (Pd(NO₃)₂.XH₂O) dissolved in water and 0.5 g of Ketchen black as carbon-based catalyst support was added to the mixture solution.

In order to adjust the pH of the mixture solution to be basic, 1M of sodium hydroxide solution was dropwise added to the mixture solution and stirring was performed for 12 hours to form a precipitate. The resultant precipitate was washed several times with water, and then was dried under a nitrogen atmosphere at a temperature of about 120° C.

Then, the resultant solid product was heat-treated at a temperature of about 300° C. in hydrogen gas to complete the manufacture of an electrode catalyst for a fuel cell.

### Example 2

### Manufacture of Electrode and Evaluation of ORR Activity

(1) Manufacture of Electrode

For each 1 g of the electrode catalyst synthesized in Example 1, 0.1 g of polyvinylidene fluoride (PVDF) and an adequate amount of NMP solvent were mixed to produce a slurry for forming a rotating disk electrode (RDE). The slurry was loaded on a glassy carbon film used as a substrate for the RDE, and then a drying process was performed in which the temperature was increased gradually from room temperature to about 150° C. to produce the RDE. The produced RDE was used as a working electrode, and the performance of the electrode catalyst was evaluated as described below.

Simultaneously, an electrode was manufactured in the same manner as described above except that the electrode catalyst manufactured in Comparative Example 1 was used.

(2) Evaluation of ORR Activity

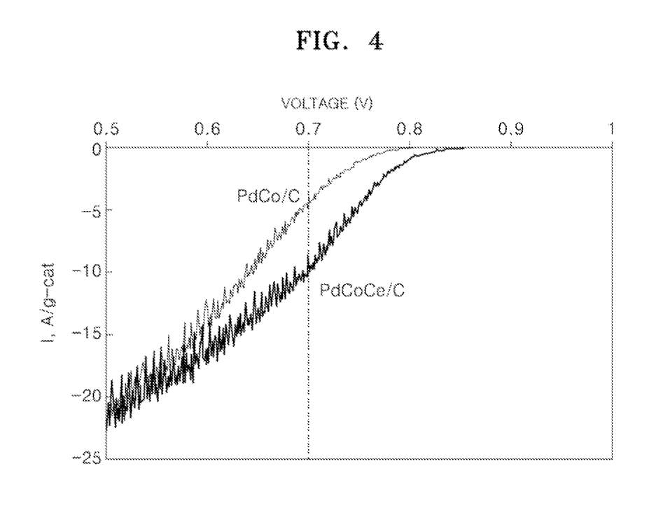

FIG. 4 is a graph illustrating the activity of oxygen reduction reaction (ORR) of the electrode catalysts of Example 1 and Comparative Example 1. ORR activity was evaluated by dissolving oxygen in an electrolyte to saturation, and then reducing the open circuit voltage (OCV) while recording the corresponding currents (scan rate: 1 mV/s, electrode rotation speed: 1000 rpm). After the OCV was reduced through an operating voltage (0.6-0.8 V), at which the oxygen reduction reaction of an electrode mainly takes place, a material limiting current was reached at a lower voltage. A material limiting current is a maximum current upon depletion of reagents, and in the RDE experiment, upon increase of the rotation speed of the electrode, the supply of oxygen dissolved in the electrolyte to the surface of the electrode was increased, thereby increasing the material limiting current, as well as the current in the entire potential region.

Referring to FIG. 4, the vertical axis represents the current standardized by an amount of catalyst per gram, i.e., A/g-cat, the horizontal axis represents the voltage of the fuel cell with reference to a reference hydrogen electrode (RHE), PdCoCe/C refers to Example 1, and PdCo/C refers to Comparative Example 1.

The ORR current was measured with respect to a voltage range from the OCV to 0.5 V by rotating the electrode in a 0.1M HClO₄ electrolyte saturated by oxygen (rpm: 900) and by changing the voltage to a scan rate of 1 mV/s. The activities of the catalysts were compared using the difference in ORR currents at a voltage close to the OCV.

Referring to FIG. 4, the Pd₃Co₁(CeO_{X})₁ catalyst of Example 1 has an ORR current of about 10 A/g at 0.7 V and the PdCo catalyst of Comparative Example 1, in which Ce is not included, has an ORR current of about 5 A/g at 0.7 V. The results show in FIG. 4 that Example 1 about doubled the ORR current of Comparative Example 1. Also, the ORR current increases in all potential regions.

### Example 3

### Manufacture and Evaluation of Fuel Cells

For each 1 g of the electrode catalyst synthesized in Example 1, 0.03 g of polyvinylidene fluoride (PVDF) and an adequate amount of NMP solvent were mixed to produce a slurry for forming a cathode. The slurry for forming a cathode was coated by a bar coater on a carbon paper coated with a microporous layer, and then a drying process was performed in which the temperature was increased gradually from room temperature to about 150° C. to produce the cathode.

Separately, a general supported PtCo catalyst (Tanaka Jewelry) was used to produce an anode. A membrane-electrode assembly (MEA) was manufactured using poly(2,5-benzimidazole) doped with 85% phosphoric acid as an electrolyte membrane in between the cathode and the anode.

Then, the MEA properties were evaluated at a temperature of about 150° C. using desiccated air supplied to the cathode and desiccated hydrogen supplied to the anode.

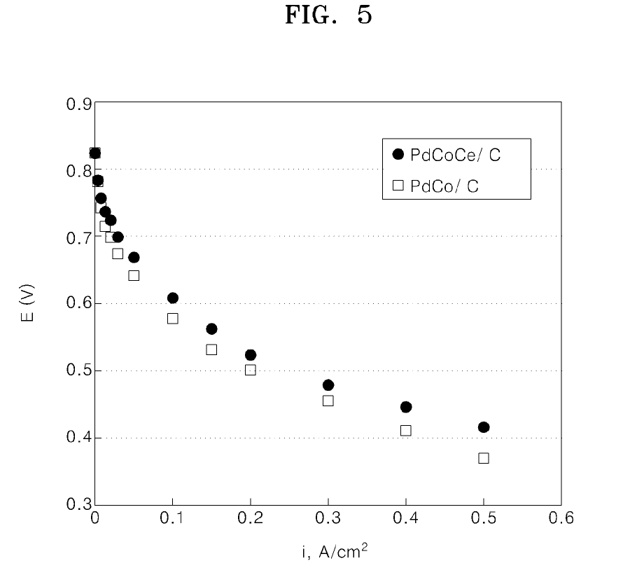

In addition, an MEA was manufactured using the electrode catalyst manufactured in Comparative Example 1. Then, the MEA was evaluated using the same method of evaluation as described above. FIG. 5 is a graph showing the change in voltage according to the current density with respect to the fuel cells manufactured using the electrode catalysts of Example 1 and Comparative Example 1. Referring to FIG. 5, PdCoCe/C refers to Example 1, and PdCo/C refers to Comparative Example 1.

Referring to FIG. 5, the electrode catalyst for a fuel cell according to the present embodiment, that is the electrode catalyst of Example 1, produces an effect of increased voltage across almost the entire operating current region.

As described above, the electrode catalyst for a fuel cell according to the one or more of the above embodiments employs a second metal catalyst derived from cerium oxide having excellent oxygen activity or transferability, thereby having excellent catalytic activity even at temperatures less than 200° C.

Although a few embodiments have been shown and described, it would be appreciated by those skilled in the art that changes may be made in these embodiments without departing from their principles and spirit, the scope of which is defined in the claims and their equivalents.

What is claimed is:

1. An electrode catalyst for a fuel cell, the electrode catalyst comprising:
a carbon-based catalyst support; and
a non-platinum (Pt) catalyst; and
a cerium (Ce) metal catalyst,
wherein the non-Pt catalyst and the Ce metal catalyst are both supported on the carbon-based catalyst support.

2. The electrode catalyst of claim 1, wherein the non-Pt catalyst comprises at least one selected from the group consisting of Mn, Pd, Ir, Au, Cu, Co, Ni, Fe, Ru, WC, W, Mo, Se, any alloys thereof, and any mixtures thereof.

3. The electrode catalyst of claim 1, wherein the non-Pt catalyst comprises one selected from the group consisting of Mn, Pd, Ir, Au, Cu, Ni, Fe, Ru, WC, W, Mo, Se, and Co.

4. The electrode catalyst of claim 1, wherein the amount of the non-Pt catalyst is 10 to 70 parts by weight, the amount of the Ce metal catalyst is 0.1 to 30 parts by weight, and the amount of the carbon-based catalyst support is 29.9 to 60 parts by weight, based on 100 parts by weight of the electrode catalyst.

5. The electrode catalyst of claim 1, wherein the Ce metal catalyst comprises CeOₓ, wherein x is in the range of about 1.5 to about 2.

6. The electrode catalyst of claim 1, wherein the non-Pt catalyst comprises one selected from the group consisting of Mn, Pd, Ir, Au, Cu, Ni, Fe, Ru, WC, W, Mo, Se, and Co, and wherein the Ce metal catalyst comprises a Ce oxide.

7. The electrode catalyst of claim 1, wherein the non-Pt catalyst comprises at least one selected from the group consisting of Pd, PdCo, PdNi, PdFe, PdAu, Ir, IrCo, IrFe, IrAu, IrPd, PdIrCo, PdIrMn, any alloys thereof, and any mixtures thereof.

8. The electrode catalyst of claim 1, wherein the non-Pt catalyst and the Ce metal catalyst are disposed adjacent to each other on the carbon-based catalyst support.

9. The electrode catalyst of claim 1, wherein the non-Pt catalyst and the Ce metal catalyst are represented by PdₐCo_{b}(CeO_{X})_{c}, wherein a is in the range of about 1.0 to about 5.0, b is in the range of about 0.5 to about 2.0, and c is in the range of about 0.1 to about 2.0.

10. The electrode catalyst of claim 9, wherein the non-Pt catalyst and the Ce metal catalyst are represented by Pd₃Co₁(CeO_{X})₁, wherein x is in the range of about 1.5 to about 2.

11. The electrode catalyst of claim 1, wherein the carbon-based catalyst support comprises one selected from the group consisting of Ketchen black, carbon black, graphite carbon, carbon nanotube, and carbon fiber.

12. A method of manufacturing an electrode catalyst for fuel cells, the method comprising:
mixing a non-platinum (Pt) catalyst precursor and a cerium (Ce) precursor in a solution to form a mixture solution;
impregnating a carbon-based catalyst support with the mixture solution; and
heat treating the resultant of the impregnation under a hydrogen atmosphere at a temperature of about 200 to about 350° C.

13. A fuel cell, comprising:
an electrode comprising an electrode catalyst for the fuel cell, the electrode catalyst comprising:
a carbon-based catalyst support;
a non-platinum (Pt) catalyst; and
a cerium (Ce) metal catalyst,
wherein the non-platinum (Pt) catalyst and the cerium (Ce) metal catalyst are both supported on the; and
an electrolyte membrane.

14. The fuel cell of claim 13, wherein the electrode is a cathode.

15. The fuel cell of claim 13, wherein the fuel cell is a polymer electrolyte membrane fuel cell (PEMFC).

16. The fuel cell of claim 13, wherein the non-Pt catalyst comprises at least one selected from the group consisting of Mn, Pd, Ir, Au, Cu, Co, Ni, Fe, Ru, WC, W, Mo, Se, any alloys thereof, and any mixtures thereof, or one selected from the group consisting of Mn, Pd, Ir, Au, Cu, Ni, Fe, Ru, WC, W, Mo, Se, and Co.

17. The fuel cell of claim 13, the amount of the non-Pt catalyst is 10 to 70 parts by weight, the amount of the Ce metal catalyst is 0.1 to 30 parts by weight, and the amount of the carbon-based catalyst support is 29.9 to 60 parts by weight, based on 100 parts by weight of the electrode catalyst.

18. The fuel cell of claim 13, wherein the Ce metal catalyst comprises CeOₓ, wherein x is in the range of about 1.5 to about 2.

19. The fuel cell of claim 13, wherein the non-Pt catalyst supported on the catalyst support and the Ce metal catalyst are represented by PdₐCo_{b}(CeO_{X})_{c}, wherein a is in the range of about 1.0 to about 5.0, b is in the range of about 0.5 to about 2.0, and c is in the range of about 0.1 to about 2.0.

20. The fuel cell of claim 13, wherein the non-Pt catalyst supported on the carbon-based catalyst support and the Ce metal catalyst are represented by Pd₃Co₁(CeO_{X})₁, wherein x is in the range of about 1.5 to about 2.
